(19) United States
(12) Patent Application Publication
(10) Pub. No.: US 2017/0079311 A1
(43) Pub. Date: Mar. 23, 2017

(54) METHOD FOR INCREASING ABSORPTION OF PLANT DERIVED PROTEINS

(71) Applicants: Ralf Jager, Milwaukee, WI (US); Mark Olson, Carlsbad, CA (US); Joseph P. Mannion, Carlsbad, CA (US); Jaroslav Boublik, Cardiff, CA (US); Martin Purpura, Austin, TX (US)

(72) Inventors: Ralf Jager, Milwaukee, WI (US); Mark Olson, Carlsbad, CA (US); Joseph P. Mannion, Carlsbad, CA (US); Jaroslav Boublik, Cardiff, CA (US); Martin Purpura, Austin, TX (US)

(21) Appl. No.: 14/857,811

(22) Filed: Sep. 17, 2015

(51) Int. Cl. A23K 1/18

(52) U.S. Cl. CPC A23L 1/3053; A23L 1/3051; A23V 2002/00

(57) ABSTRACT

A method for improving the absorption of amino acids from protein sources include adding one or more carbohydrases to a protein source. Plant protein such as that found in rice may be extracted to provide a rice concentrate useful in regimens requiring elevated amounts of protein consumption. To improve the absorption of the amino acids found in rice inside the human gastrointestinal tract, a carbohydrases such as Alpha-galactidase is added to the protein source prior to ingestion. The composition may also include proteases.

### CROSS-REFERENCE TO RELATED APPLICATIONS

This application claims priority to U.S. Provisional Application Ser. No. 62/051,839 filed on Sep. 17, 2014, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

Field of the Invention

The present invention relates to a method and composition for improving the amino acid absorption by oral ingestion of plant derived protein sources. More particularly, the invention relates to the use of additives including digestive proteases to plant protein sources to increase absorption following oral ingestion.

Description of the Related Art

The ISSN recommends that exercising individuals consume between 1.4-2.0 g/kg/day of protein before, during, and after exercise sessions to improve adaptations to exercise training and to maintain or increase muscle mass (Campbell et al., Journal of the International Society of Sports Nutrition 2007, 4:8). The growth of muscle and its control are important factors not only in athletes or healthy humans but also in disease and disease management, human growth and development. To fuel the muscle after workout, or any kind of exercise, athletes and recreational sports people have different choices of protein sources; animal protein (e.g. whey, casein, egg, beef, fish) or plant protein (e.g. soy, rice, pea, hemp) sources, which differ in numerous ways such as protein content, digestion rate (fast, intermediate, or slow absorption of amino acids), or the relative amount of individual amino acids as well as other ingredients like fats, carbohydrates, including sugars and/or fibers.

The biological importance of protein digestion is widely known and described. In healthy humans a patented blend of digestive proteases (Aminogen®), a patented blend of digestive proteases from Aspergillus niger and Aspergillus oryzae, increased the absorption rate of processed whey protein concentrate over controls (Oben et al., J Int Soc Sports Nutr. 2008, 5:10.).

A further study has indicated that plant protein sources like rice protein isolate compared to whey protein isolate (fast) and casein (slow) is an intermediate digesting protein (Jager et al., J Int Soc Sports Nutr. 2013; 10(Suppl 1): P12.). The protein digestibility differs between protein sources with animal proteins (whey protein concentrate 100%, casein 99%) generally being better absorbed than plant proteins (soy protein isolate 95% (Gilani et al., Nutr. J 2003, 133(1):220-225), pea 93.5% (Eggum et al., Plant Foods Hum Nutr 1989, 39:13-21) or rice protein isolate 87% (Morita et al., J Food Sci 1993, 58:1393-1396).

Another study has shown that the total amino acid plasma concentration was increased to a similar extent 20 min after healthy subjects consumed pea and whey peptide hydrolysates. In contrast, the administration of a milk solution resulted in a slower rise in total amino acid plasma concentration (Calbet et al., J Nutr. 2002 August; 132(8):2174-82.). After the whole postprandial period of 180 min the whey peptide hydrolysate solution had the greatest increase in total amino acid plasma concentration compared to pea peptide hydrolysate and milk solution.

U.S. Pat. No. 5,387,422A describes a method of using an enzyme food supplement composition to convert, in the gastrointestinal system of a human being, ingested dietary protein into free amino acids and short chain peptides by using a combination of at least one acid protease fungal enzyme and at least one semi-alkaline protease fungal enzyme (Handel et al.).

US20130156884A1 describes the use of food supplement comprising one fungal or bacterial protease enzyme, which exhibits increased proteolytic activity producing increased protein digestion rate and absorption in the presence of pepsin (Anderson). This method of increasing protein absorption in the gastrointestinal system of a human being comprises the step of ingesting the food supplement in combination with protein.

Nutritional analysis of whey protein hydrolysates, casein, and pea and rice protein isolate shows a max. 18% content of carbohydrates in these protein sources, with lower concentrations of carbohydrates in animal sources, and higher amounts in plant proteins (Table 1). While dairy protein sources contain simple sugars, mainly lactose, plant protein surprisingly contain more complex carbohydrates, including fibers.

TABLE 1
Partial Nutrition Facts of Different Protein Sources

| Partial | Whey | Casein | | |
|---|---|---|---|---|
| Nutrition Facts | Concentrate | Powder | Rice Protein | Pea Protein |
| Total | Approx. 6% | Approx. 4% | Max. 18% | Max. 10% |
| Carbohydrates | | | | |
| Protein | 80% | 86% | 80% | 80% |

Adding a blend of digestive proteases seems to overcome possible inhibition of endogenous digestive enzymes and reduced transit time in the intestine to improve the overall absorption rate of processed whey protein concentrate.

While digestibility of animal protein sources like whey protein is considered to be superior compared to plant protein sources like rice, pea, hemp or others and their combinations there is clearly a necessity to improve the digestibility of plant protein sources.

Therefore, there is a need for a method and composition to improve the amino acid absorption after oral ingestion of plant derived protein sources.

### BRIEF SUMMARY OF THE INVENTION

Disclosed is a method of oral administration of compositions having plant derived protein and an effective amount of a complex of enzymes sufficient to affect the digestibility rate and relative amount of individual amino acids of plant protein sources in a mammal. A combination of enzymes with the orally ingested plan protein improves absorption into the bloodstream along the gastro-intestinal tract. A complex of proteases and carbohydrases that may include an alpha-galactosidase and/or a complex of enzymes, improves and enhances protein digestion rates and the relative amount of individual amino acids from plant protein sources in individuals, compared to the oral use of only adding digestive proteases.

Accordingly, the present invention provides a method of adding at least one digestive carbohydrase in combination with proteases to plant protein sources, thereby increasing the digestion and absorption rates and relative amounts of individual amino acids of plant protein sources in a mammal, compared to adding only proteases to plant protein sources. Without being bound by theory, the inventors believe that the addition of a carbohydrase increases the accessibility of body-own and added proteases to the plant protein source, thereby increasing the digestion of the protein and the subsequent absorption of individual amino acids and peptides.

The present application discloses a suitable composition derived from complex of enzymes combining digestive proteases and at least one digestive carbohydrase, preferably a combination of protease 6.0, protease 4.5, peptidase, bromelain and alpha-galactosidase, including maltodextrin as inactive filling material, at least 0.2%, more preferably 0.3-0.5% to 99.8-99.5% plant protein sources of rice, pea, hemp and other plant protein sources and/or mixes thereof. This composition of complex of enzymes is comprised of at least with an enzyme activity for protease 6.0 of 4,000 HUT, more preferably 5,000-6,000 HUT, for protease 4.5 of 7,000 HUT, more preferably 8,000-9,000 HUT, for peptidase of 1,500 HUT, more preferably 2,000-3,000 HUT, for bromelain of 150,000 FCCPU, more preferably 200,000-300,000 FCCPU, and at least for alpha-galactosidase of 200 GalU, more preferably 250-300 GalU. Filling components include maltodextrin or microcrystalline cellulose or other appropriate filling material. These components neither increase nor interfere with the enzymes activity.

Enzyme complexes can be mixed with the plant protein sources and incorporated in the manufacture of foods, drugs, and dietary supplements of complex formulations and various dosage forms including capsules, tablets, caplets, lozenges, liquids, solid foods, powders and other dosage forms that may be developed, without the need to impart enteric protection to the entire mixture, any other part of the mixture, or finished products. Any suitable method of delivery and/or administration of the proprietary enzymes complex in combination with the plant protein sources are considered within the scope of this invention, including for example and not by way of limitation, tablet, capsule, powder, granule, pellet, soft gel, hard gel, controlled release form, liquid, solution, elixir, syrup, suspension, emulsion, gel, lotion, and the like.

Compositions of the present invention may also be administered in nutraceutical or functional foods. In addition the effective amount of the proprietary enzymes complex may be combined with amino acids, botanicals, functional foods, herbals, nucleotides, nutraceuticals, pharmaceuticals, proteins, and/or vitamins in an effort to enhance the targeted activity.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a graph of leucine absorption over time for different protein compositions in accordance with the principles of the invention;

FIG. 2 is a graph of isoleucine absorption over time for different protein compositions in accordance with the principles of the invention;

FIG. 3 is a graph of branched chain amino acid absorption over time for different protein compositions in accordance with the principles of the invention;

FIG. 4 is another graph of branched chain amino acid absorption over time for different protein compositions in accordance with the principles of the invention;

FIG. 5 is a graph of all amino acid absorption over time for different protein compositions in accordance with the principles of the invention;

FIG. 6 is a graph of nonessential amino acid absorption over time for different protein compositions in accordance with the principles of the invention;

FIG. 7 is a graph of the essential amino acid absorption over time for different protein compositions in accordance with the principles of the invention;

FIG. 8 is a graph of calculated confidence intervals using Tukey statistical analysis of the data obtained for the absorption over time of different protein compositions in accordance with the principles of the invention;

FIG. 9 is a graph of arginine absorption over time for different protein compositions in accordance with the principles of the invention;

FIG. 10 is another graph of arginine absorption over time for different protein compositions in accordance with the principles of the invention;

FIG. 11 is a graph of glutamine absorption over time for different protein compositions in accordance with the principles of the invention;

FIG. 12 is another graph of glutamine absorption over time for different protein compositions in accordance with the principles of the invention;

FIG. 13 is a graph of citrulline absorption over time for different protein compositions in accordance with the principles of the invention;

FIG. 14 is another graph of citrulline absorption over time for different protein compositions in accordance with the principles of the invention;

FIG. 15 is a graph of serine absorption over time for different protein compositions in accordance with the principles of the invention;

FIG. 16 is another graph of serine absorption over time for different protein compositions in accordance with the principles of the invention;

FIG. 17 is a graph of asparagine absorption over time for different protein compositions in accordance with the principles of the invention;

FIG. 18 is another graph of asparagine absorption over time for different protein compositions in accordance with the principles of the invention;

FIG. 19 is a graph of glycine absorption over time for different protein compositions in accordance with the principles of the invention;

FIG. 20 is another graph of glycine absorption over time for different protein compositions in accordance with the principles of the invention;

FIG. 21 is a graph of threonine absorption over time for different protein compositions in accordance with the principles of the invention;

FIG. 22 is another graph of threonine absorption over time for different protein compositions in accordance with the principles of the invention;

FIG. 23 is a graph of alanine absorption over time for different protein compositions in accordance with the principles of the invention;

FIG. 24 is another graph of alanine absorption over time for different protein compositions in accordance with the principles of the invention;

FIG. 25 is a graph of ornithine absorption over time for different protein compositions in accordance with the principles of the invention;

FIG. 26 is another graph of ornithine absorption over time for different protein compositions in accordance with the principles of the invention;

FIG. 27 is a graph of methionine absorption over time for different protein compositions in accordance with the principles of the invention;

FIG. 28 is another graph of methionine absorption over time for different protein compositions in accordance with the principles of the invention;

FIG. 29 is a graph of proline absorption over time for different protein compositions in accordance with the principles of the invention;

FIG. 30 is another graph of proline absorption over time for different protein compositions in accordance with the principles of the invention;

FIG. 31 is a graph of lysine absorption over time for different protein compositions in accordance with the principles of the invention;

FIG. 32 is another graph of lysine absorption over time for different protein compositions in accordance with the principles of the invention;

FIG. 33 is a graph of aspartic acid absorption over time for different protein compositions in accordance with the principles of the invention;

FIG. 34 is another graph of aspartic acid absorption over time for different protein compositions in accordance with the principles of the invention;

FIG. 35 is a graph of histidine absorption over time for different protein compositions in accordance with the principles of the invention;

FIG. 36 is another graph of histidine absorption over time for different protein compositions in accordance with the principles of the invention;

FIG. 37 is a graph of valine absorption over time for different protein compositions in accordance with the principles of the invention;

FIG. 38 is another graph of valine absorption over time for different protein compositions in accordance with the principles of the invention;

FIG. 39 is a graph of glutamic acid absorption over time for different protein compositions in accordance with the principles of the invention;

FIG. 40 is a another graph of glutamic acid absorption over time for different protein compositions in accordance with the principles of the invention;

FIG. 41 is a graph of tryptophan absorption over time for different protein compositions in accordance with the principles of the invention;

FIG. 42 is another graph of tryptophan absorption over time for different protein compositions in accordance with the principles of the invention;

FIG. 43 is a graph of leucine absorption over time for different protein compositions in accordance with the principles of the invention;

FIG. 44 is another graph of leucine absorption over time for different protein compositions in accordance with the principles of the invention;

FIG. 45 is a graph of phenylalanine absorption over time for different protein compositions in accordance with the principles of the invention;

FIG. 46 is another graph of phenylalanine absorption over time for different protein compositions in accordance with the principles of the invention;

FIG. 47 is a graph of isoleucine absorption over time for different protein compositions in accordance with the principles of the invention;

FIG. 48 is another graph of isoleucine absorption over time for different protein compositions in accordance with the principles of the invention;

FIG. 49 is a graph of cystine absorption over time for different protein compositions in accordance with the principles of the invention;

FIG. 50 is another graph of cystine absorption over time for different protein compositions in accordance with the principles of the invention;

FIG. 51 is a graph of tyrosine absorption over time for different protein compositions in accordance with the principles of the invention;

FIG. 52 is another graph of tyrosine absorption over time for different protein compositions in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practices and carried out in various ways. Also, it is to be understood that the phraseology and terminology employed herein are for the purpose of description and should not be regarded as limiting.

Disclosed is a method of increasing absorption through the gastro-intestinal tract of amino acids upon oral ingestion of a plant-based protein source by the addition of one or more carbohydrases to the plant-based protein source prior to ingestion. This may be incorporated into other known methods of increasing amino acid absorption, such as for example the addition of proteases to the protein source.

### Example 1

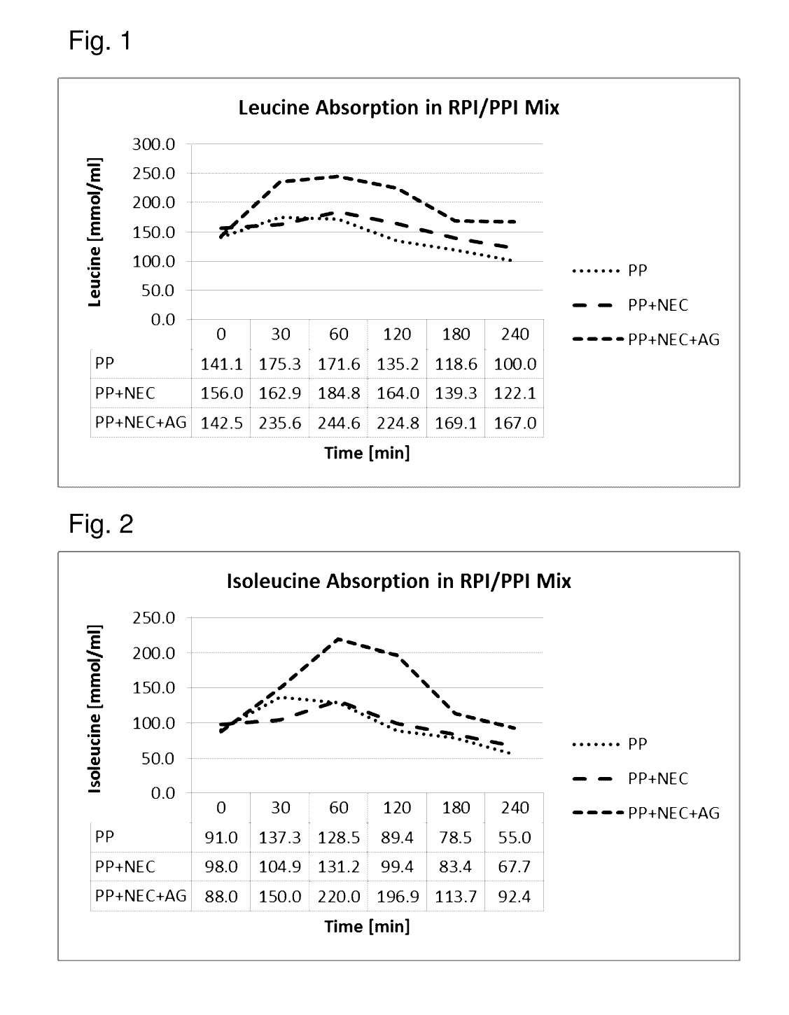

To investigate the amino acid rate of appearance in the blood in a study with one individual male subject (22 years old, bodyweight 78 kg, and height of 177 cm) received randomly after a 12 hour overnight fast either 48 grams of rice protein isolate (Growing Naturals Rice Protein Isolate made with Oryzatein® rice protein, Axiom Foods, Oro Valley, Ariz.)=PP, or the same 48 g rice protein isolate with a digestive blend, consisting of Protease 6.0, Protease 4.5, Peptidase and Bromelain (National Enzyme Company, NEC Blend, Forsythe, Mo.)=PP+NEC, or 48 g rice protein isolate with a digestive blend, consisting of Protease 6.0, Protease 4.5, Peptidase and Bromelain, plus alpha-Galactosidase (National Enzyme Company, Forsythe, Mo.)=PP+NEC+AG in a double-blind, crossover design, separated by a washout phase of 7 days. Blood draws were taken immediately prior to, and at 30, 60, 120, 180 and 240 minutes following consumption and analyzed for leucine and isoleucine content. The results are shown in FIGS. 1 and 2.

While the addition of NEC increase plasma concentrations of leucine and isoleucine, the addition of AG to NEC showed a significant increase of amino acid absorption over plant protein alone, and plant protein plus NEC.

### Example 2

To investigate the amino acid rate of appearance in the blood in a pilot study with one individual male subject (22 years old, bodyweight 78 kg, and height of 177 cm) received randomly after a 12 hour overnight fast either 48 g whey protein concentrate (Milk Specialties Group Whey Protein Concentrate, Eden Prairie, Minn.=WPI), or 48 grams of rice protein isolate (Growing Naturals Rice Protein Isolate made with Oryzatein® rice protein, Axiom Foods, Oro Valley, Ariz.) with a digestive blend, consisting of Protease 6.0, Protease 4.5, Peptidase and Bromelain (National Enzyme Company, NEC Blend, Forsythe, Mo.)=PP+NEC, or 48 g of the same rice protein isolate with a digestive blend, consisting of Protease 6.0, Protease 4.5, Peptidase and Bromelain, plus alpha-Galactosidase (National Enzyme Company, Forsythe, Mo.)=PP+NEC+AG in a double-blind, crossover design, separated by a washout phase of 7 days. Blood draws were taken immediately prior to, and at 30, 60, 120, 180 and 240 minutes following consumption. The absorptions as a function of time are shown in FIG. 3. The results again indicate an increase in absorption.

### Example 3

To investigate the amino acid rate of appearance in the blood in a study with eleven male athletes (21.4±1.5 years, 177.3±6.1 cm height, 82.5±3.9 kg weight, 2.3±1.9 years training status) received randomly after a 12 hour overnight fast either 48 g whey protein concentrate (Milk Specialties Group Whey Protein Concentrate, Eden Prairie, Minn.), or the same 48 g whey protein concentrate with a digestive blend, consisting of Protease 6.0, Protease 4.5, Peptidase and Bromelain (National Enzyme Company, Forsythe, Mo.), or 48 grams of rice protein isolate (Growing Naturals Rice Protein Isolate made with Oryzatein® rice protein, Axiom Foods, Oro Valley, Ariz.), or 48 g of the same rice protein isolate with a digestive blend, consisting of Protease 6.0, Protease 4.5, Peptidase and Bromelain, plus alpha-Galactodidase (National Enzyme Company, Forsythe, Mo.) in a double-blind, crossover design, separated by a washout phase of 7 days. Blood draws were taken immediately prior to, and at 30, 60, 120, 180 and 240 minutes following consumption.

The subjects were divided into four groups, each receiving a different blend. Group 1=whey protein concentrate; Group 2=rice/pea protein; Group 3=whey protein plus NEC; Group 4=rice/pea protein plus NEC plus AG.

Whey protein=60 g of powder=49 g of protein. The term “rice” in the charts and graphs refers to a rice/pea blend (60 g of powder consisting of pea protein isolate (42 g) (Vegotein 80) and Rice concentrate (18 g) Oryzatein 80)=44.4 g of total protein. Results are not normalized for protein content.

Combined BCAA Analysis:

| | | | WHEY PLUS | RICE PLUS |
|---|---|---|---|---|
| | WHEY | RICE | ENZYME | ENZYME |
| First X = | 0.0 | 0.0 | 0.0 | 0.0 |
| Last X = | 240.0 | 240.0 | 240.0 | 240.0 |
| Peak X = | 60.00 | 60.00 | 120.0 | 30.00 |
| Peak Y = | 1187 | 868.7 | 1213 | 977.4 |
| Area = | 235831 | 183387 | 243715* | 207008 |
| % Area = | 100.0 | 100.0 | 100.0 | 100.0 |

*Greater than rice.

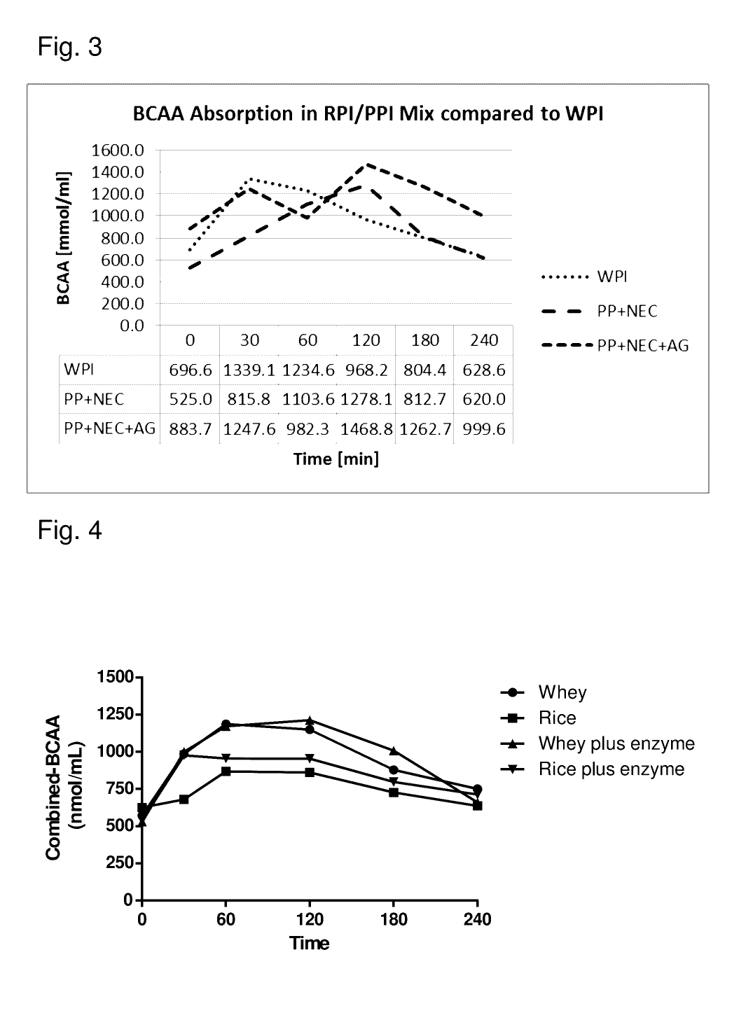

FIG. 4 shows the absorption of amino acids as a function of time for the Branched Chain Amino Acids (“BCAA”). The inclusion of the enzyme

Combined All AA Analysis:

| | | | WHEY PLUS | RICE PLUS |
|---|---|---|---|---|
| | WHEY | RICE | ENZYME | ENZYME |
| First X = | 0.0 | 0.0 | 0.0 | 0.0 |
| Last X = | 240.0 | 240.0 | 240.0 | 240.0 |
| Peak X = | 60.00 | 60.00 | 60.00 | 30.00 |
| Peak Y = | 5694 | 4940 | 5525 | 4937 |
| Area = | 1.187e+006 | 1.071e+006 | 1.200e+006 | 1.084e+006 |
| % Area = | 100.0 | 100.0 | 100.0 | 100.0 |

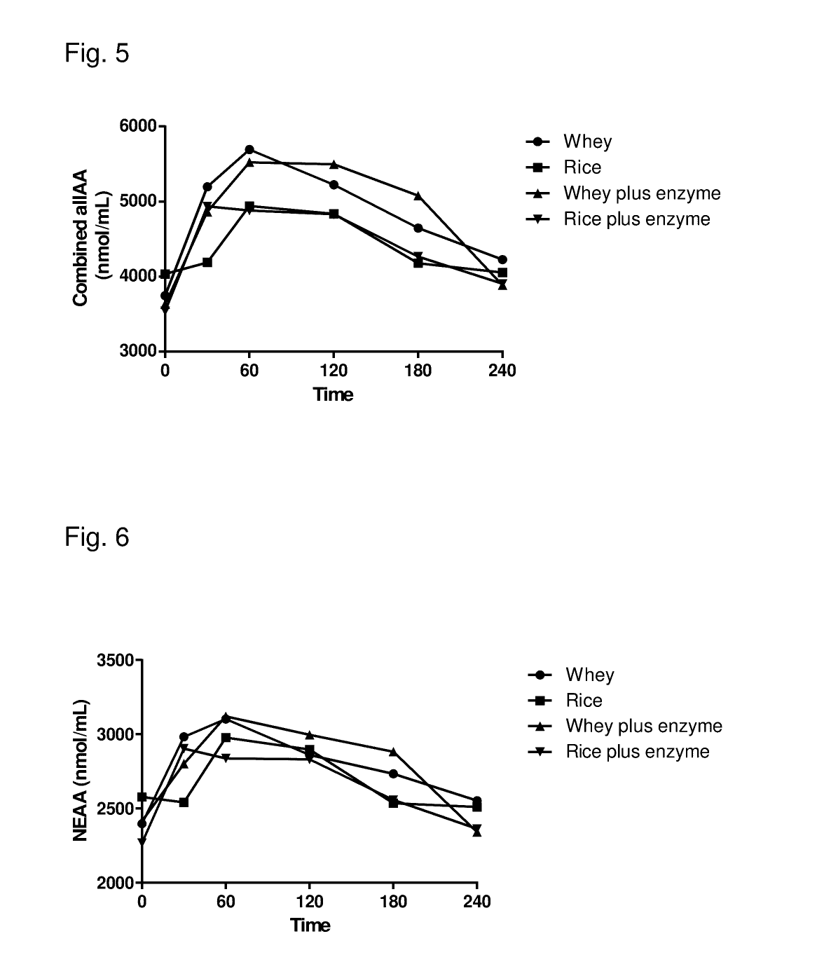

FIG. 5 shows absorption vs time for all amino acids.

Combined NEAA Analysis

| | | | Whey plus | |
|---|---|---|---|---|
| | Whey | Rice | enzyme | Rice plus enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 30.00 |
| Peak Y = | 3103 | 2978 | 3121 | 2905 |
| Area = | 677467 | 650329 | 683781 | 643228 |
| % Area = | 100.0 | 100.0 | 100.0 | 100.0 |

FIG. 6 shows the results for Non-Essential Amino Acids (“NEAA”).

Combined EAA

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 60.00 | 60.00 | 120.0 | 60.00 |
| Peak Y = | 2591 | 1962 | 2498 | 2042 |
| Area = | 509766 | 420666 | 516023 | 440483 |
| % Area = | 100.0 | 100.0 | 100.0 | 100.0 |

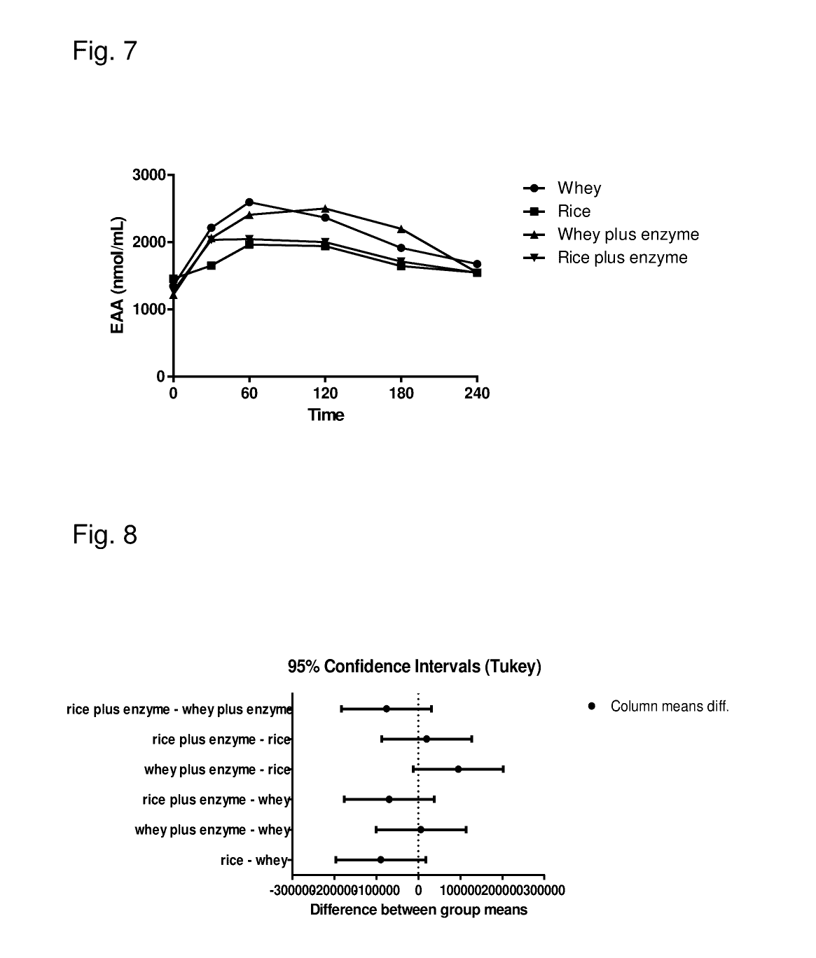

FIG. 7 shows the results for Essential Amino Acids (“EAA”).

FIG. 8 shows provides statistical analysis commonly known as Tukey's test, verifying the accuracy of the results of the data shown in FIGS. 5-7.

The method disclosed herein provides for different rates of absorption for individual amino acids. Specifically as shown below:

Arginine:

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 60.00 |
| Peak Y = | 113.4 | 143.6 | 121.2 | 154.1 |
| Area = | 20449 | 26225* | 25839 | 30924*** |
| % Area = | 100.0 | 100.0 | 100.0 | 100.0 |

*Greater than whey
***Greater than whey

| Arginine | P-Value | Significant |
|---|---|---|
| Interaction | <.0001 | Yes |
| Time | <.0001 | Yes |
| Group | .0004 | Yes |

| Time Point | Groups | Mean Diff |
|---|---|---|
| 30 min | Group 1 vs 2 | −28.55 |
| 30 min | Group 1 vs 4 | −46.17 |
| 30 min | Group 3 vs 4 | −35.73 |
| 60 min | Group 1 vs 2 | −30.15 |
| 60 min | Group 1 vs 4 | −40.68 |
| 60 min | Group 3 vs 4 | −32.86 |
| 120 min | Group 1 vs 3 | −28.82 |
| 120 min | Group 1 vs 4 | −53.41 |
| 120 min | Group 2 vs 4 | −33.26 |
| 180 min | Group 1 vs 3 | −37.66 |
| 180 min | Group 1 vs 4 | −46.12 |
| 240 min | Group 1 vs 2 | −26.36 |
| 240 min | Group 1 vs 4 | −38.10 |

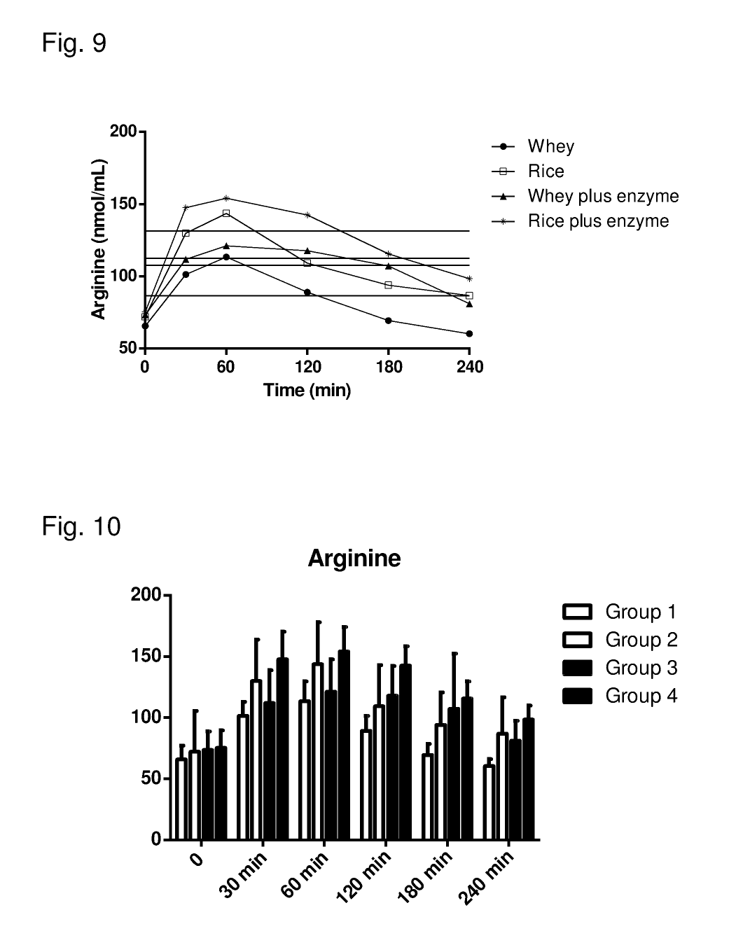

These results are shown in FIGS. 9 and 10.

Glutamine:

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 180.0 | 60.00 | 60.00 | 30.00 |
| Peak Y = | 928.3 | 884.5 | 893.5 | 854.9 |
| Area = | 210226 | 200906 | 200840 | 197001 |
| % Area = | 100.0 | 100.0 | 100.0 | 100.0 |

| Glutamine | P-Value | Significant |
|---|---|---|
| Interaction | .72 | No |
| Time | .35 | No |
| Group | .94 | No |

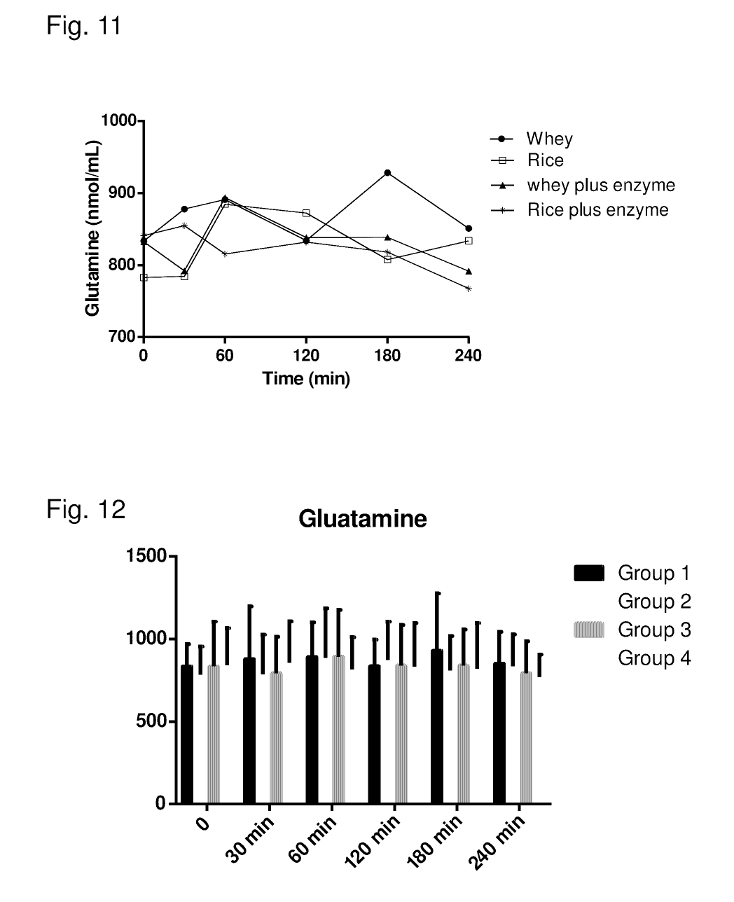

These results are shown in FIGS. 11 and 12.

Citrulline:

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 120.0 | 120.0 | 120.0 | 120.0 |
| Peak Y = | 37.05 | 29.00 | 34.85 | 30.52 |
| Area = | 7301 | 6144 | 7300 | 6582 |
| % Area = | 100.0 | 100.0 | 100.0 | 100.0 |

| Citruline | P-Value | Significant |
|---|---|---|
| Interaction | .08 | No |
| Time | <.0001 | Yes |
| Group | .62 | No |

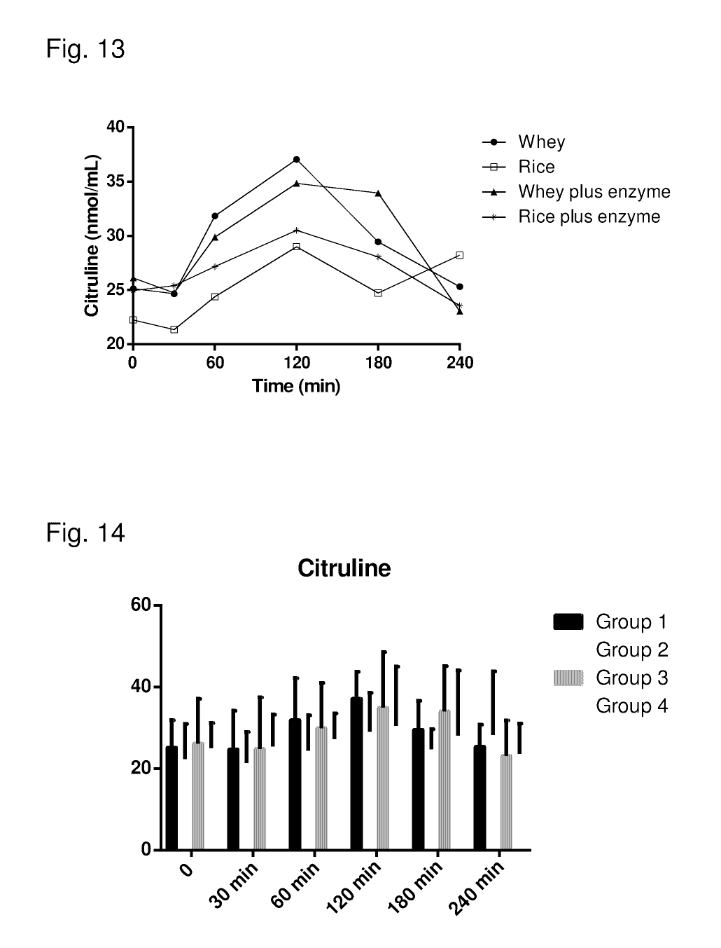

These results are shown in FIGS. 13 and 14.

Serine:

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 30.00 |
| Peak Y = | 229.9 | 234.8 | 241.4 | 243.5 |
| Area = | 48332 | 48042 | 53318 | 51425 |
| % Area = | 100.0 | 100.0 | 100.0 | 100.0 |

| Serine | P-Value | Significant |
|---|---|---|
| Interaction | .14 | No |
| Time | <.0001 | Yes |
| Group | .94 | No |

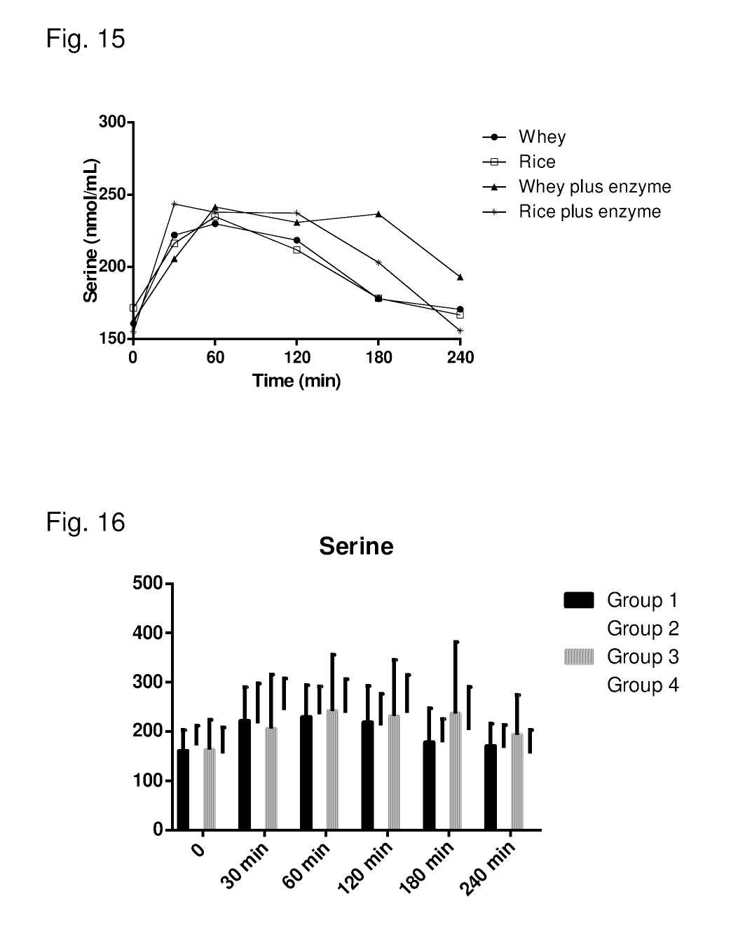

These results are shown in FIGS. 15 and 16.

Asparagine:

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 120.0 |
| Peak Y = | 180.1 | 211.0 | 256.2 | 221.0 |
| Area = | 35815 | 45238 | 49055! | 47199* |
| % Area = | 100.0 | 100.0 | 100.0 | 100.0 |

*Greater than rice
!Greater than rice plus enzyme

| Asparagine | P-Value | Significant |
|---|---|---|
| Interaction | .13 | No |
| Time | <.0001 | Yes |
| Group | .25 | No |

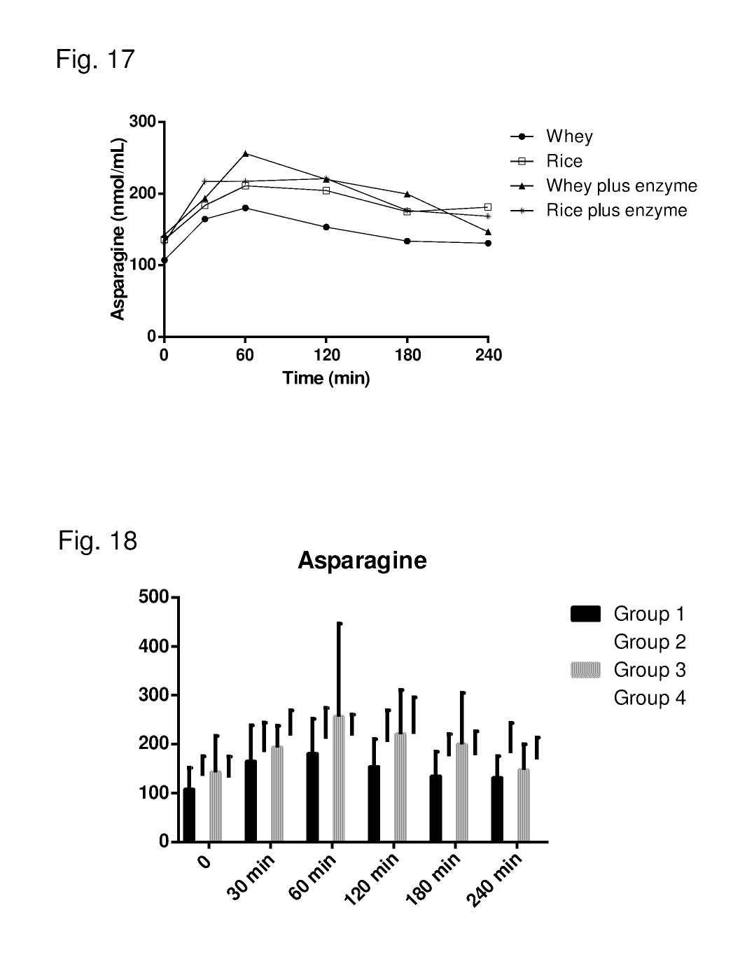

These results are shown in FIGS. 17 and 18.

Glycine:

| | | | Whey | |
|---|---|---|---|---|
| | Whey | Rice | plus enzyme | Rice plus enzyme |
| First X = | 0.0 | 0.0 | 0.0 | 0.0 |
| Last X = | 240.0 | 240.0 | 240.0 | 240.0 |
| Peak X = | 30.00 | 0.0 | 30.00 | 30.00 |
| Peak Y = | 331.8 | 342.3 | 333.9 | 375.3 |
| Area = | 72690 | 70184 | 73163 | 69788 |
| % Area = | 100.0 | 100.0 | 100.0 | 100.0 |

| Glycine | P-Value | Significant |
|---|---|---|
| Interaction | .21 | No |
| Time | .0041 | Yes |
| Group | .99 | No |

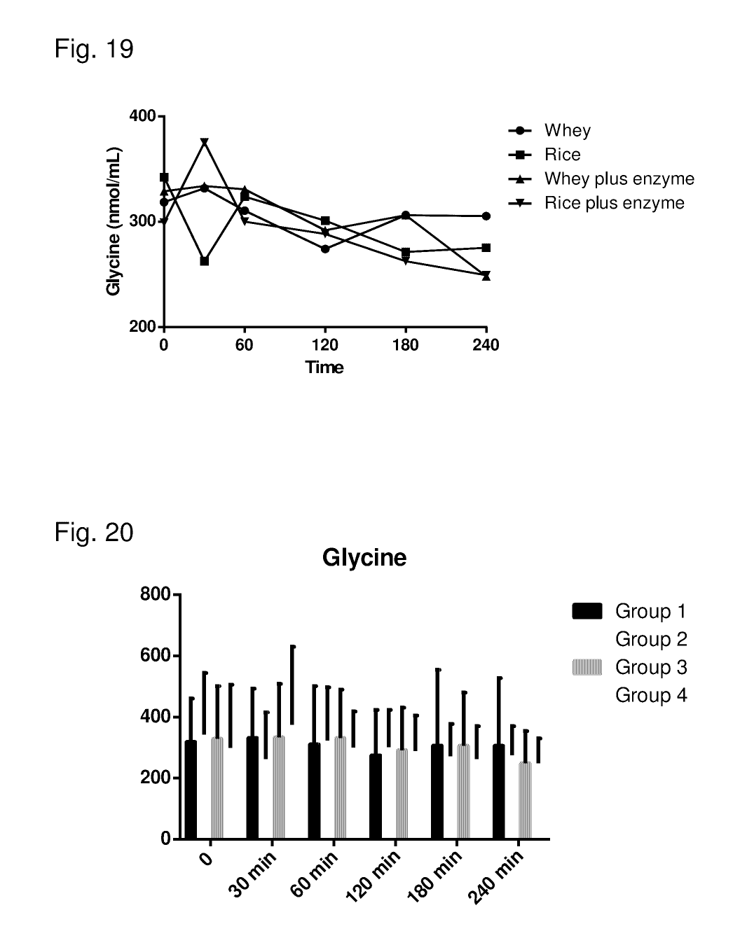

These results are shown in FIGS. 19 and 20.

Threonine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 120.0 | 120.0 | 60.00 |
| Peak Y = | 397.2 | 267.3 | 370.3 | 272.8 |
| Area = | 79825 | 59205 | 80109 | 59712 |
| % Area = | 100.0 | 100.0 | 100.0 | 100.0 |

| Threonine | P-Value | Significant |
|---|---|---|
| Interaction | <.0001 | Yes |
| Time | <.0001 | Yes |
| Group | .08 | No |

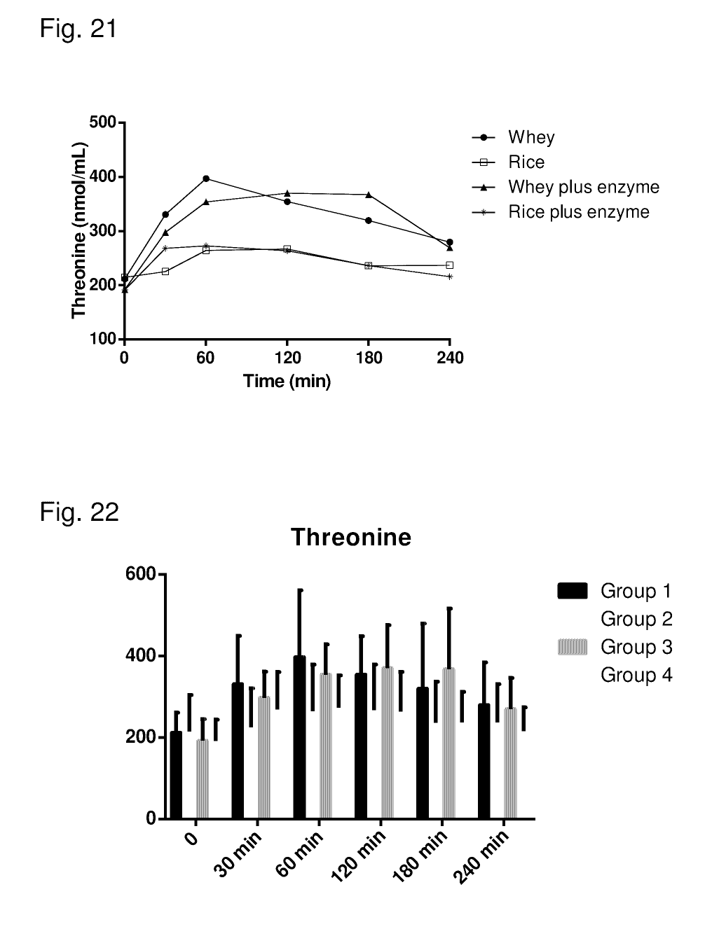

These results are shown in FIGS. 21 and 22.

Alanine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 0.0 | 60.00 | 120.0 |
| Peak Y = | 546.8 | 488.7 | 504.2 | 405.4 |
| Area = | 118259 | 92799 | 110090 | 87461 |
| % Area = | 100.0 | 100.0 | 100.0 | 100.0 |

| Alanine | P-Value | Significant |
|---|---|---|
| Interaction | .0002 | Yes |
| Time | <.0001 | Yes |
| Group | .35 | No |

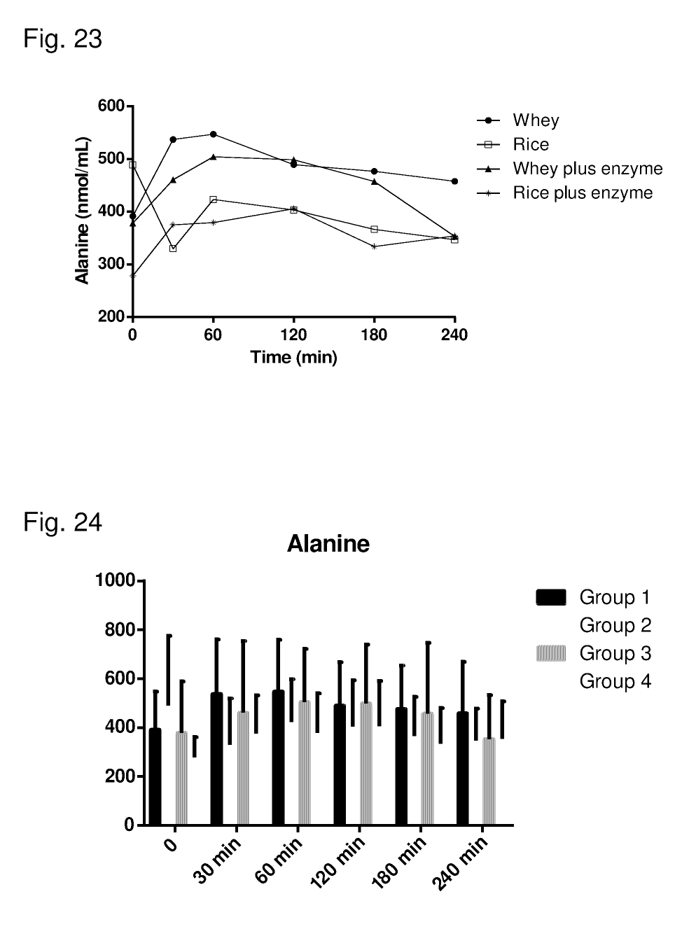

These results are shown in FIGS. 23 and 24.

Ornithine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 120.0 | 120.0 | 60.00 | 180.0 |
| Peak Y = | 121.9 | 134.0 | 80.66 | 108.3 |
| Area = | 26228 | 26692 | 17958 | 23751 |
| % Area = | 100.0 | 100.0 | 100.0 | 100.0 |

| Ornithine | P-Value | Significant |
|---|---|---|
| Interaction | .10 | No |
| Time | <.0001 | Yes |
| Group | .09 | No |

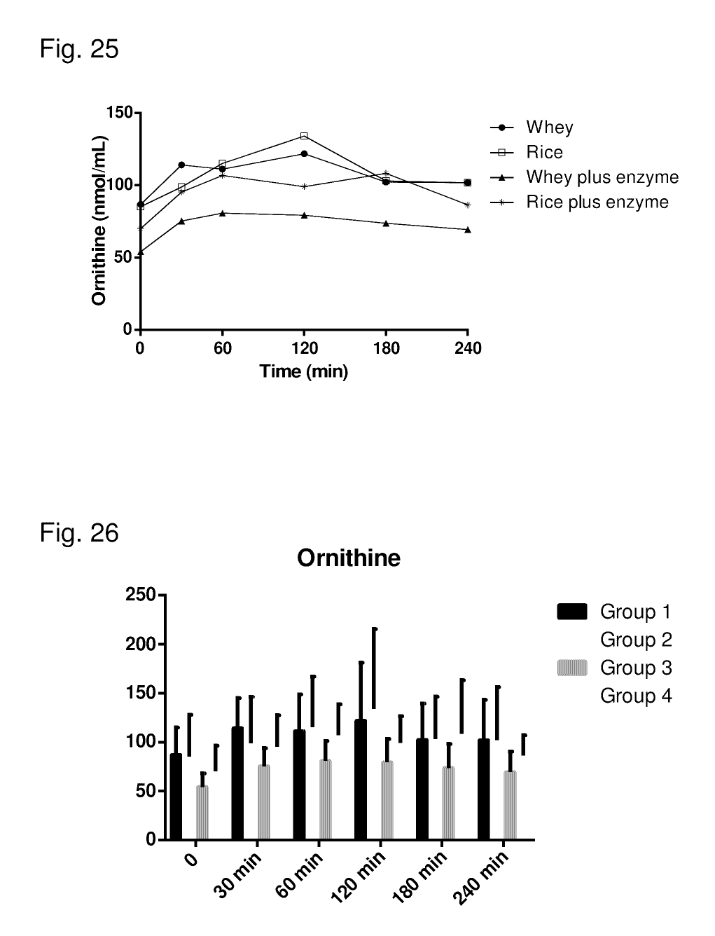

These results are shown in FIGS. 25 and 26.

Methionine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 120.0 | 60.00 |
| Peak Y = | 68.15 | 34.77 | 61.33 | 41.57 |
| Area = | 11664* | 7092 | 12177! | 8399 |
| % Area = | 100.0 | 100.0 | 100.0 | 100.0 |

| Methionine | P-Value | Significant |
|---|---|---|
| Interaction | <.0001 | Yes |
| Time | <.0001 | Yes |
| Group | .005 | Yes |

| Time Point | Groups | Mean Diff |
|---|---|---|
| 30 min | Group 1 vs 2 | 24.00 |
| 30 min | Group 1 vs 4 | 18.35 |
| 30 min | Group 2 vs 3 | −18.32 |
| 60 min | Group 1 vs 2 | 33.38 |
| 60 min | Group 1 vs 4 | 26.58 |
| 60 min | Group 2 vs 3 | −23.14 |
| 120 min | Group 1 vs 2 | 22.94 |
| 120 min | Group 2 vs 3 | −29.94 |
| 120 min | Group 3 vs 4 | 21.16 |
| 180 min | Group 2 vs 3 | −24.22 |
| 180 min | Group 3 vs 4 | 19.01 |

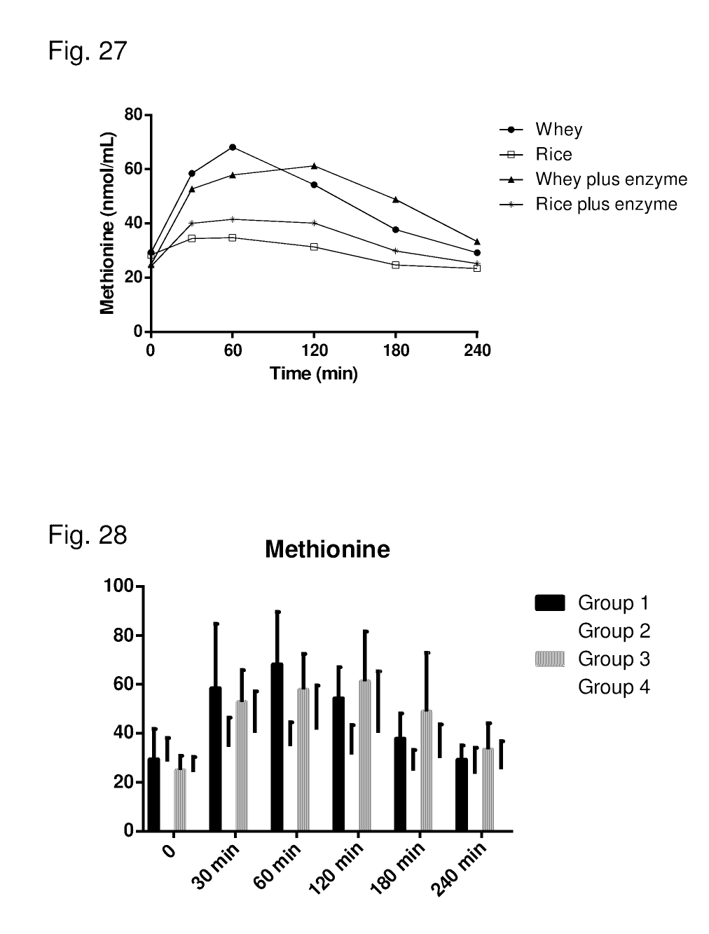

These results are shown in FIGS. 27 and 28.

Proline:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 120.0 | 120.0 | 60.00 |
| Peak Y = | 411.7 | 343.8 | 398.0 | 336.1 |
| Area = | 86318 | 74546 | 85511 | 74196 |
| % Area = | 100.0 | 100.0 | 100.0 | 100.0 |

| Proline | P-Value | Significant |
|---|---|---|
| Interaction | <.0001 | Yes |
| Time | <.0001 | Yes |
| Group | .58 | No |

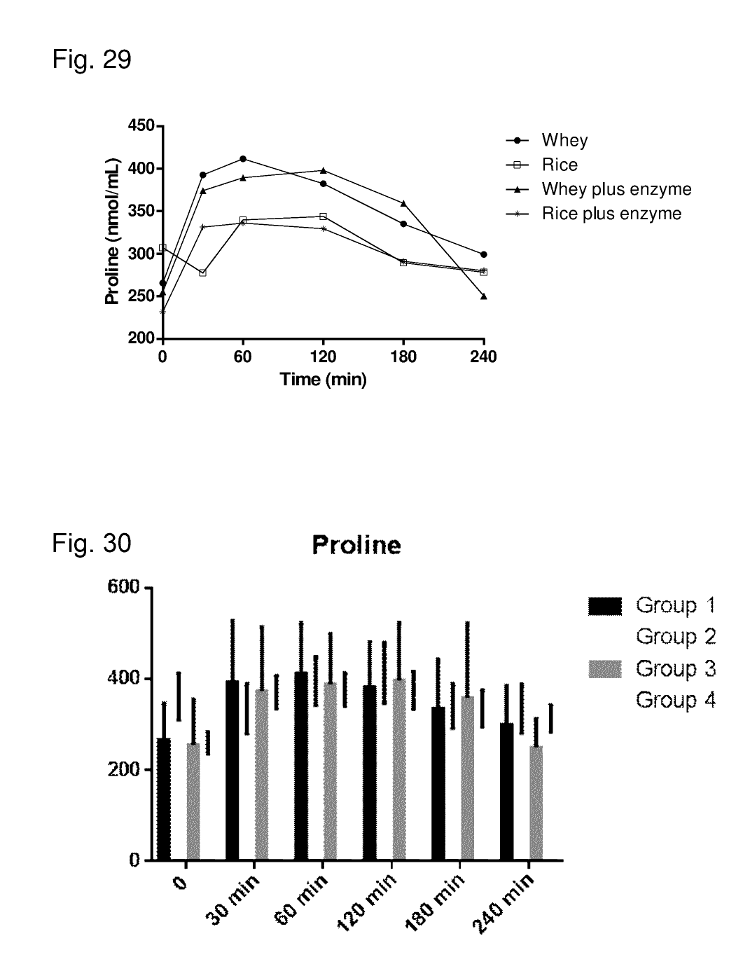

These results are shown in FIGS. 29 and 30.

Lysine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 120.0 | 60.00 |
| Peak Y = | 571.1 | 446.1 | 485.8 | 416.9 |
| Area = | 106435 | 91496 | 100673 | 86761 |
| % Area = | 100.0 | 100.0 | 100.0 | 100.0 |

| Lysine | P-Value | Significant |
|---|---|---|
| Interaction | <.0001 | Yes |
| Time | <.0001 | Yes |
| Group | .19 | No |

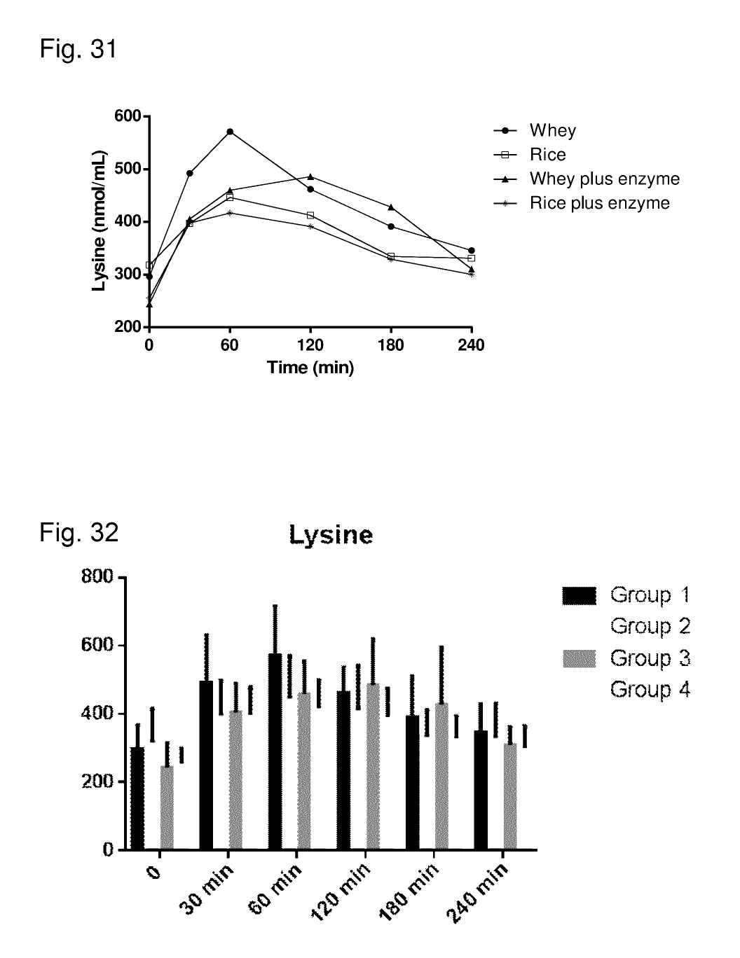

These results are shown in FIGS. 31 and 32.

Aspartic Acid:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 120.0 | 60.00 |
| Peak Y = | 17.93 | 12.01 | 18.14 | 10.90 |
| Area = | 2569 | 2202 | 3548 | 1925 |
| % Area = | 100.0 | 100.0 | 100.0 | 100.0 |

| Aspartic Acid | P-Value | Significant |
|---|---|---|
| Interaction | .046 | No |
| Time | <.0001 | Yes |
| Group | .06 | No |

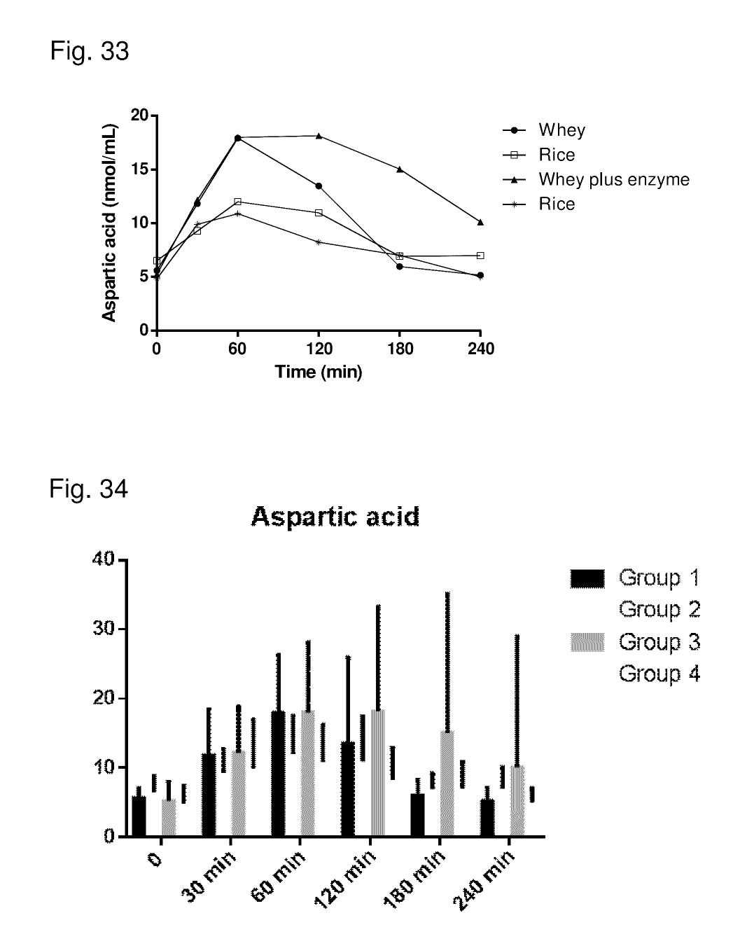

These results are shown in FIGS. 33 and 34.

Histidine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 30.00 | 120.0 | 60.00 | 30.00 |
| Peak Y = | 97.65 | 108.5 | 90.67 | 114.3 |
| Area = | 17148 | 23097 | 20322 | 24085* |
| % Area = | 100.0 | 100.0 | 100.0 | 100.0 |

| Histidine | P-Value | Significant |
|---|---|---|
| Interaction | .056 | No |
| Time | .0015 | Yes |
| Group | .08 | No |

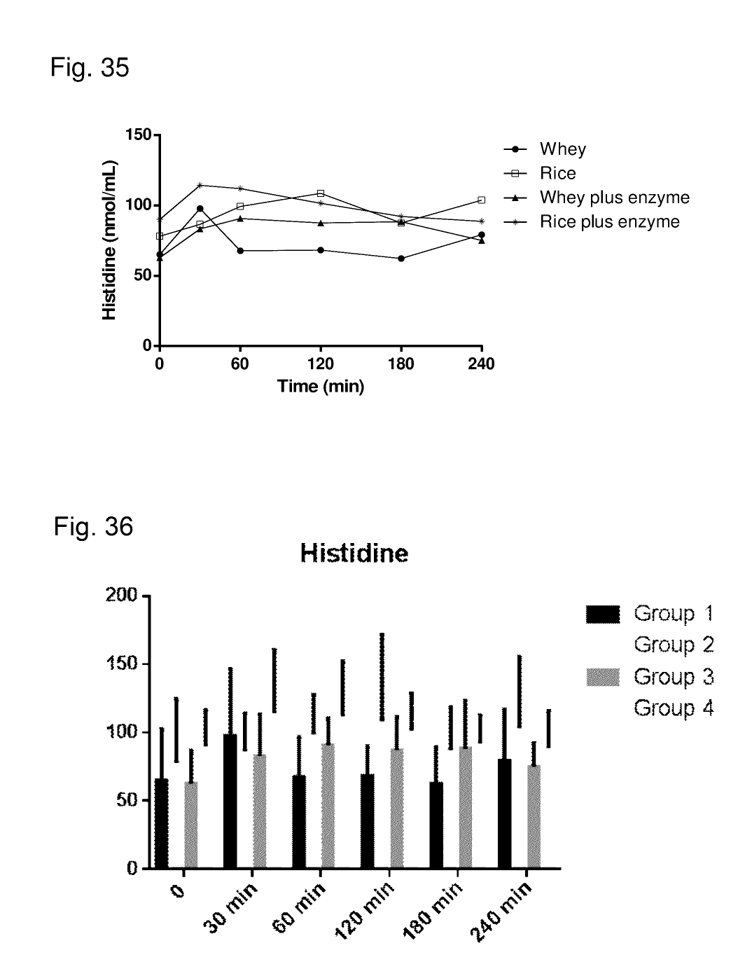

These results are shown in FIGS. 35 and 36.

Valine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 120.0 | 120.0 | 120.0 | 120.0 |
| Peak Y = | 549.3 | 448.1 | 540.1 | 451.0 |
| Area = | 117119 | 95907 | 111476 | 99943 |
| % Area = | 100.0 | 100.0 | 100.0 | 100.0 |

| Valine | P-Value | Significant |
|---|---|---|
| Interaction | <.0001 | Yes |
| Time | <.0001 | Yes |
| Group | .44 | No |

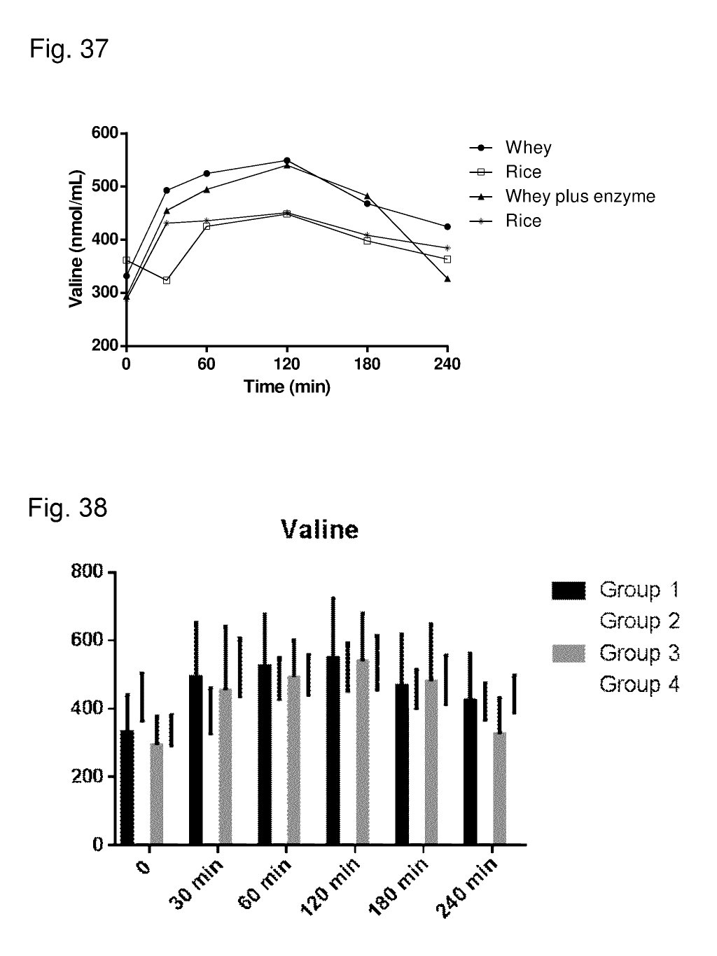

These results are shown in FIGS. 37 and 38.

Glutamic Acid:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 60.00 |
| Peak Y = | 108.2 | 81.20 | 90.60 | 76.97 |
| Area = | 17926 | 15735 | 18300 | 14608 |
| % Area = | 100.0 | 100.0 | 100.0 | 100.0 |

| Glutamic Acid | P-Value | Significant |
|---|---|---|
| Interaction | .047 | Yes |
| Time | <.0001 | Yes |
| Group | .57 | No |

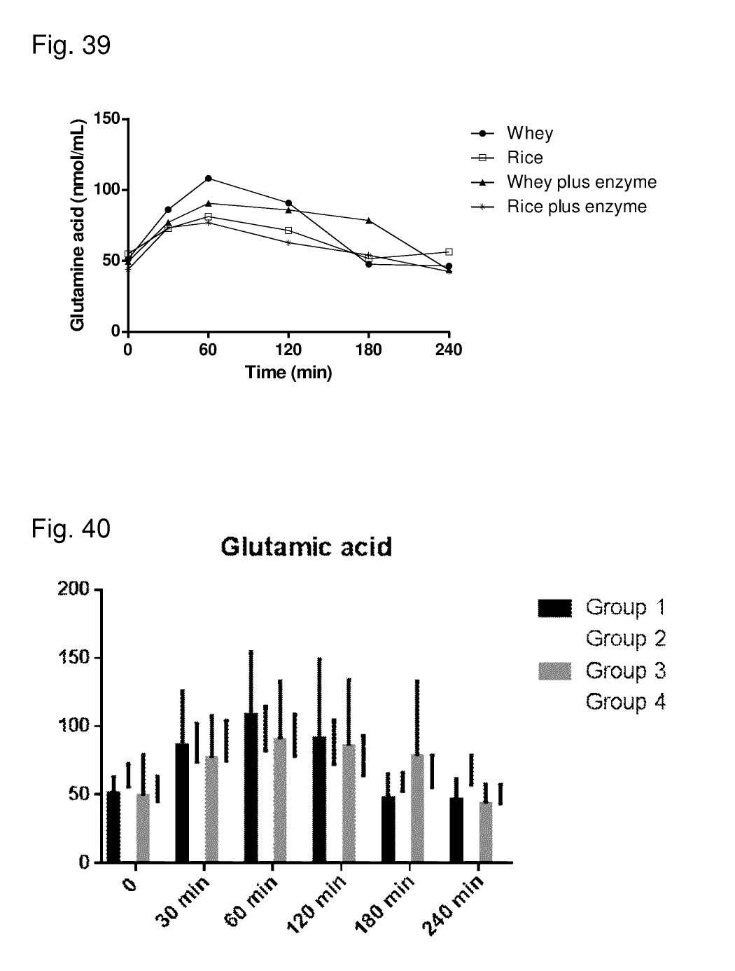

These results are shown in FIGS. 39 and 40.

Tryptophan:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 120.0 | 120.0 | 120.0 |
| Peak Y = | 181.4 | 142.4 | 177.0 | 131.2 |
| Area = | 36219 | 31989 | 36219 | 29045 |
| % Area = | 100.0 | 100.0 | 100.0 | 100.0 |

| Tryptophan | P-Value | Significant |
|---|---|---|
| Interaction | <.0001 | Yes |
| Time | <.0001 | Yes |
| Group | .19 | No |

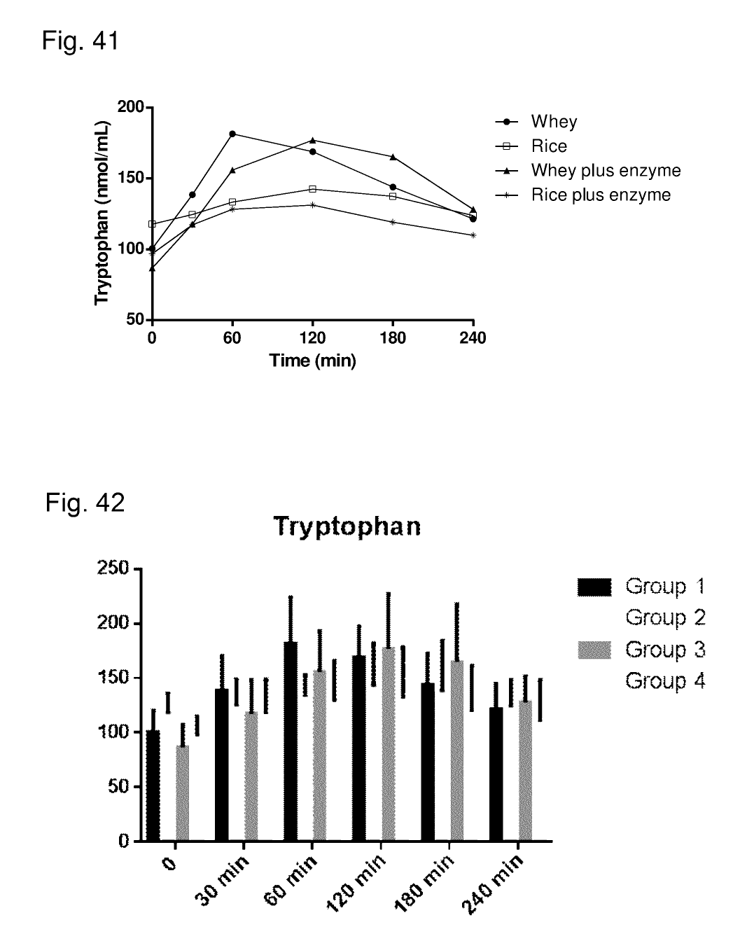

These results are shown in FIGS. 41 and 42.

Leucine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 120.0 | 30.00 |
| Peak Y = | 427.2 | 285.6 | 440.9 | 353.9 |
| Area = | 78121* | 56379 | 86155!# | 67433 |
| % Area = | 100.0 | 100.0 | 100.0 | 100.0 |

*Greater than rice
!Greater than rice
#Greater than rice plus enzyme

| Leucine | P-Value | Significant |
|---|---|---|
| Interaction | <.0001 | Yes |
| Time | <.0001 | Yes |
| Group | .0030 | Yes |

| Time Point | Groups | Mean Diff |
|---|---|---|
| 30 min | Group 2 vs 3 | −102.1 |
| 30 min | Group 2 vs 4 | −122.3 |
| 60 min | Group 1 vs 2 | 141.6 |
| 60 min | Group 1 vs 4 | 109.9 |
| 60 min | Group 2 vs 3 | −152.0 |
| 60 min | Group 3 vs 4 | 120.2 |
| 120 min | Group 1 vs 2 | 144.1 |
| 120 min | Group 2 vs 3 | −182 |
| 120 min | Group 3 vs 4 | 130.9 |
| 180 min | Group 2 vs 3 | −133.5 |
| 180 min | Group 3 vs 4 | 96.9 |

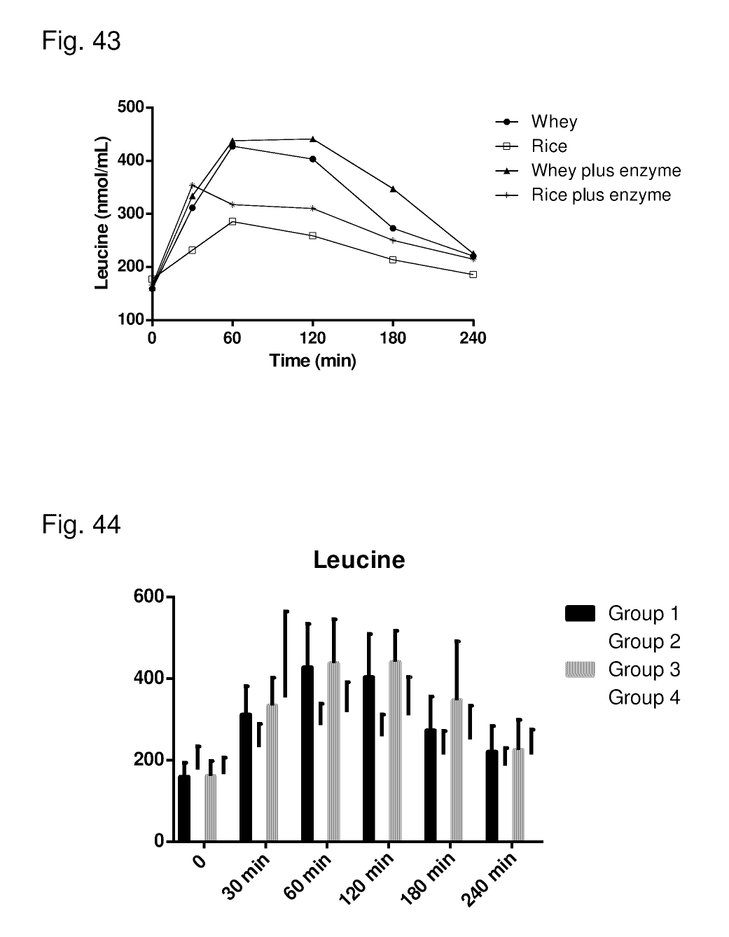

These results are shown in FIGS. 43 and 44.

Phenylalanine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 30.00 |
| Peak Y = | 117.9 | 115.9 | 113.7 | 116.4 |
| Area = | 22646 | 24400 | 22811 | 25469 |
| % Area = | 100.0 | 100.0 | 100.0 | 100.0 |

| Phenylalanine | P-Value | Significant |
|---|---|---|
| Interaction | .04 | Yes |
| Time | <.0001 | Yes |
| Group | .68 | No |

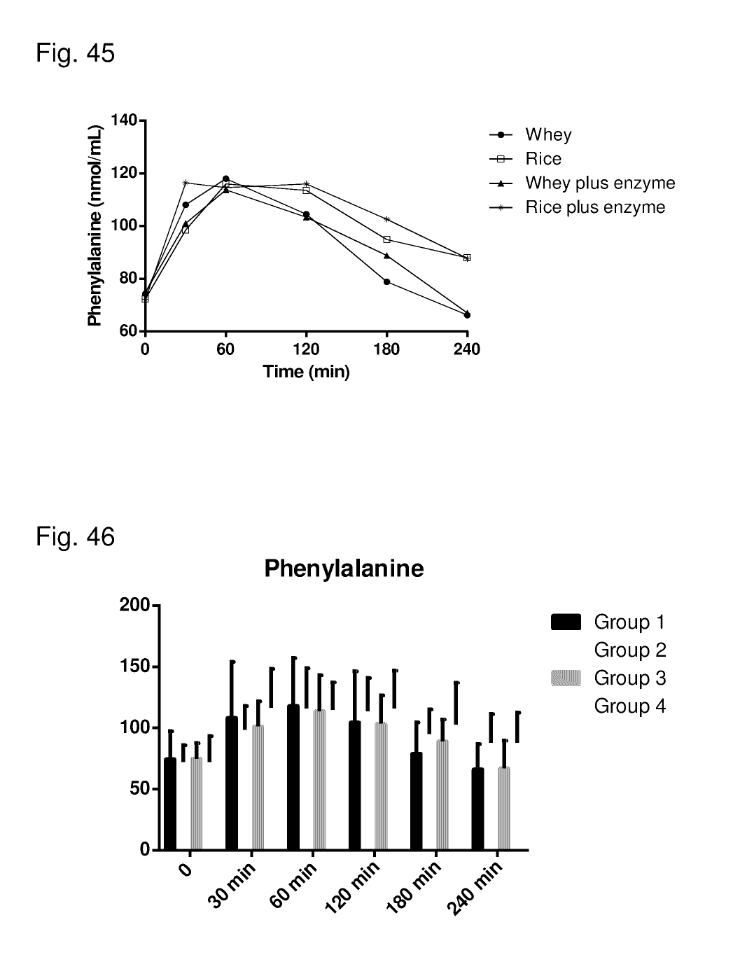

These results are shown in FIGS. 45 and 46.

Isoleucine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 60.00 | 60.00 | 60.00 | 60.00 |
| Peak Y = | 235.6 | 158.1 | 239.7 | 203.2 |
| Area = | 40592 | 31102 | 46084 | 39636 |
| % Area = | 100.0 | 100.0 | 100.0 | 100.0 |

| Isoleucine | P-Value | Significant |
|---|---|---|
| Interaction | <.0001 | Yes |
| Time | <.0001 | Yes |
| Group | .0042 | Yes |

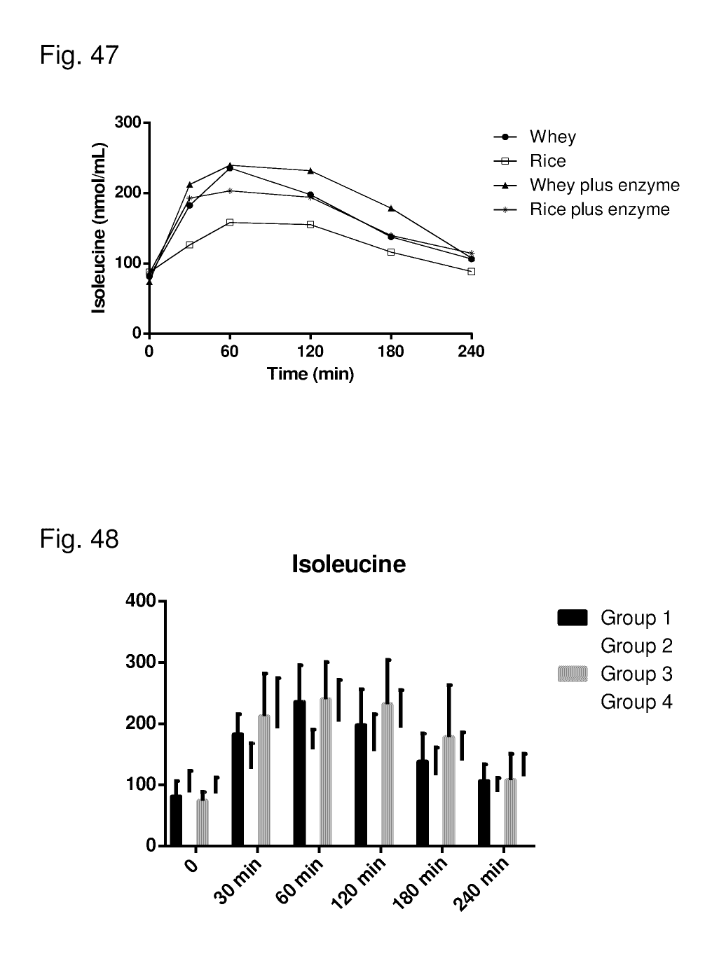

These results are shown in FIGS. 47 and 48.

Cystine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 120.0 | 120.0 | 180.0 | 60.00 |
| Peak Y = | 31.06 | 25.57 | 40.27 | 31.95 |
| Area = | 6303 | 5896 | 8412* | 6875 |
| % Area = | 100.0 | 100.0 | 100.0 | 100.0 |

STRONG TREND/DIFFERENCE BETWEEN WHEY PLUS ENZYME AND WHEY
*Greater than Rice

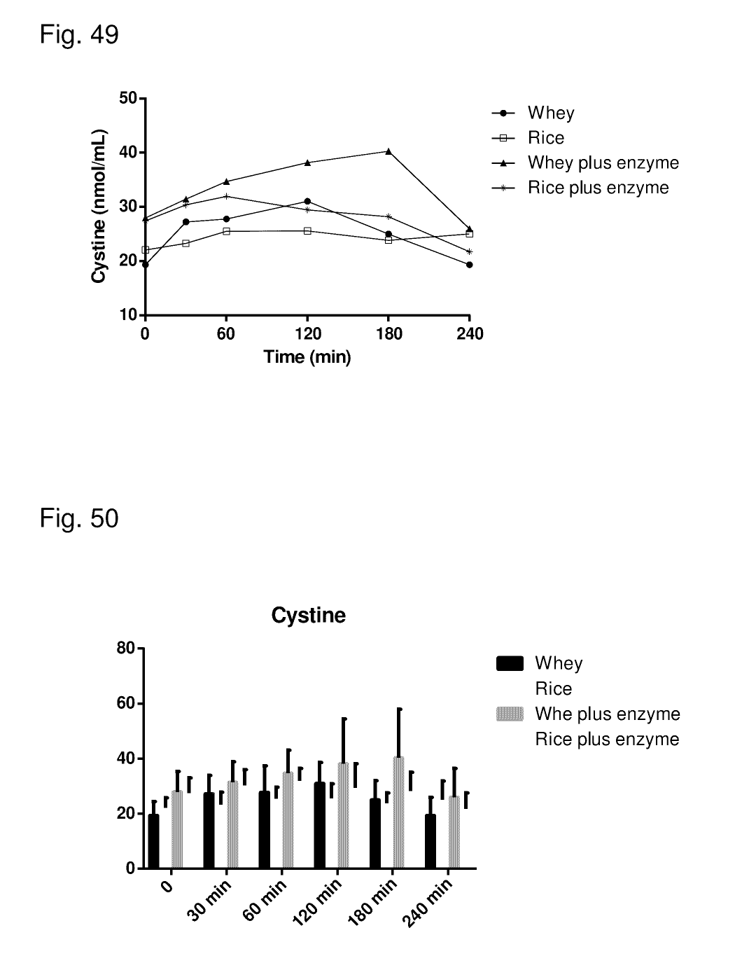

These results are shown in FIGS. 49 and 50.

Tyrosine:

| | | | Whey plus | Rice plus |
|---|---|---|---|---|
| | Whey | Rice | enzyme | enzyme |
| First X = | 0.0 | 0.0 | 0.0 | 0.0 |
| Last X = | 240.0 | 240.0 | 240.0 | 240.0 |
| Peak X = | 120.0 | 120.0 | 120.0 | 120.0 |
| Peak Y = | 126.4 | 182.2 | 145.2 | 145.6 |
| Area = | 25054 | 35717* | 30441 | 31496 |
| % Area = | 100.0 | 100.0 | 100.0 | 100.0 |

*Greater than whey

| Tyrosine | P-Value | Significant |
|---|---|---|
| Interaction | .08 | No |
| Time | <.0001 | Yes |
| Group | .0177 | Yes |

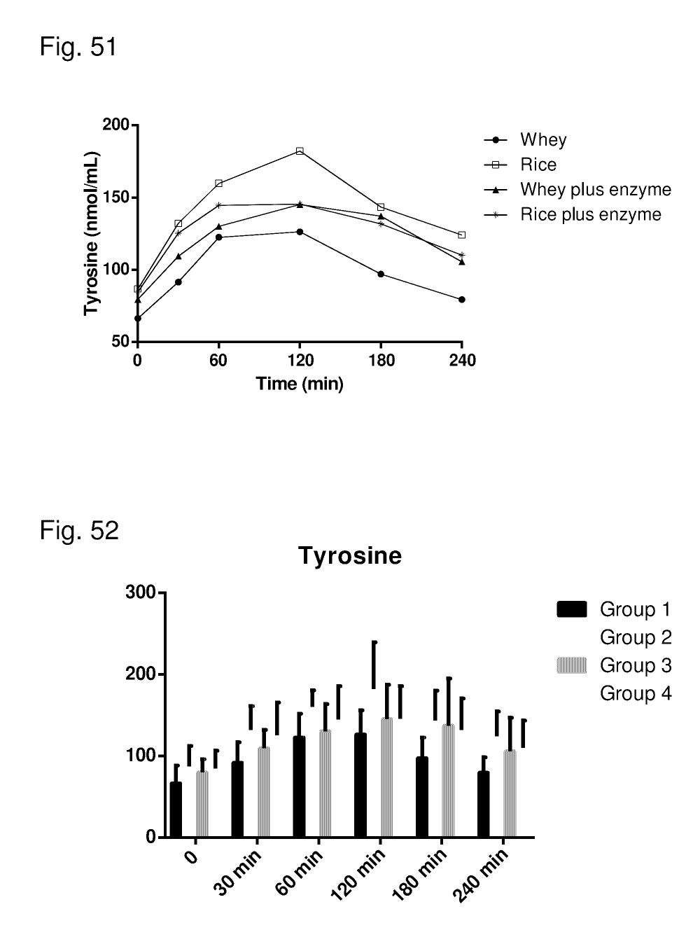

These results are shown in FIGS. 51 and 52.

The examples all show an increase in absorption of amino acids when AG is included in the digestive blend. AG is a typical carbohydrase and its activity if indicative of other carbohydrases.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A method for increasing the absorption of amino acids after oral ingestion of plant derived protein sources comprising orally ingesting a protein source and a mixture of one or more digestive proteases and one or more carbohydrases.

2. The method according to claim 1 wherein the mixture of digestive proteases comprises protease 6.0 and 4.5, peptidase, bromelain and at least one carbohydrase.

3. The method of claim 2 wherein the at least one carbohydrase comprises alpha-galactosidase.

4. The method of claim 3 further comprising an inactive filling material, wherein the inactive filling material is maltodextrin.

5. The method of claim 4 wherein the inactive filling material comprises maltodextrin or crystalline cellulose.

6. The method of claim 4 wherein the plant derived protein source comprises at least one protein source selected from the group consisting of rice, pea, hemp and mixtures thereof.

7. The method of claim 2 wherein the mixture of one or more digestive proteases has an enzyme activity for protease 6.0 of 4,000 HUT, for protease 4.5 of 7,000 HUT, for peptidase of 1,500 HUT, for bromelain of 150,000 FCCPU, and the carbohydrase comprises alpha-galactosidase having an activity of 200 GalU.

8. The method of claim 2 wherein the mixture of one or more digestive proteases has an enzyme activity for protease 6.0 of 5,000-7,000 HUT, for protease 4.5 of 8,000-9,000 HUT, for peptidase of 2,000-3,000 HUT, for bromelain of 200,000-300,000 FCCPU, and the carbohydrase comprises alpha-galactosidase having an activity of 250-300 GalU.

9. A method according to claim 1, wherein the filling components of the complex of digestive enzymes include but not limited to maltodextrin or microcrystalline cellulose.
